(19) United States
(12) Patent Application Publication
(10) Pub. No.: US 2013/0221731 A1
(43) Pub. Date: Aug. 29, 2013

(54) WHEEL FOR A MOTOR VEHICLE

(71) Applicants: Heiko HESS, Lauterecken (DE); Sven Wenigmann, Mannheim (DE); Gerhard Bohrmann, Bohl-Iggelheim (DE); Uwe Gleiter, Neustadt (DE); Walter Rau, Mannheim (DE); Volker Hummel, Lenningen (DE)

(72) Inventors: Heiko HESS, Lauterecken (DE); Sven Wenigmann, Mannheim (DE); Gerhard Bohrmann, Bohl-Iggelheim (DE); Uwe Gleiter, Neustadt (DE); Walter Rau, Mannheim (DE); Volker Hummel, Lenningen (DE)

(73) Assignees: Hummel-Formen GmbH, Lenningen (DE); BASF SE, Ludwigshafen (DE)

(21) Appl. No.: 13/594,073

(22) Filed: Aug. 24, 2012

Related U.S. Application Data
(60) Provisional application No. 61/527,131, filed on Aug. 25, 2011.

(51) Int. Cl. B60B 19/00; B29D 99/00

(52) U.S. Cl. CPC B60B 19/00; B29D 99/0032
USPC 301/37.101; 156/242; 29/894.3

(57) ABSTRACT

The invention relates to a wheel for a motor vehicle, comprising a wheel body (3) with a rim tape (7) for receiving a tire and a rim star (9) or a wheel disk, through-holes (13) for receiving fastening means (17) of the wheel body (3) on a vehicle axle being formed in the rim star or in the wheel disk. The wheel body (3) is produced from a reinforced polymer material and is connected non-positively, positively or integrally to a cap (5), the cap (5) covering the rim star (9) or the wheel disk. Furthermore, the invention also relates to a process for producing the wheel.

The invention proceeds from a wheel for a motor vehicle, comprising a wheel body with a rim tape for receiving a tire and a rim star or a wheel disk, through-holes for receiving fastening means of the wheel body on a vehicle axle being formed in the rim star or in the wheel disk.

At present, wheels for motor vehicles are produced from metallic materials, usually from steel or aluminum. The wheel is generally fastened to a wheel mounting, usually a brake drum or brake disk, on the motor vehicle by spherical-head screws or conical-head screws. As a result, the wheel is pressed against the mounting and the force transmission from the vehicle drive to the wheel is brought about by friction between the wheel and the area of contact of the wheel on the wheel mounting.

To reduce the fuel consumption of the motor vehicle, and consequently to save energy, it is intended to reduce the weight of the motor vehicle. For this purpose, it is endeavored, for example, to produce as many components of the motor vehicle as possible from materials of low weight, for example from plastics, and to replace the currently used metallic materials by plastics.

It is already known from DE-U 297 06 229 to produce wheels for a motor vehicle from a fiber-reinforced plastic. However, on account of the great forces that are transmitted to the wheel, the plastic of the wheel does have a tendency to creep, which can lead to deformation of the wheel. Furthermore, high forces act on the wheel body and the through-holes, through which the screws for mounting the wheel are guided, and there is the risk that the wheel body will begin to creep in the region of the through-holes and as a result will also be deformed. Even fiber reinforcement is generally not sufficient here to prevent the creep and the associated deformation. Moreover, too high a proportion of fibers, that would ensure sufficient strength with respect to the tendency to creep, has the effect that the material from which the rim is produced becomes too brittle, and consequently does not withstand the loads that occur during driving with the motor vehicle. This is manifested by cracks in the rim, for example, which may lead to rupturing.

A wheel made of a plastics material is likewise known from DE-A 42 23 290. Here, a compound synthetic resin wheel is joined together with two or more partial castings to form a single structural unit. Here, at least one of the partial castings comprises a thermally curing synthetic resin reinforced by means of long fibers, and the other partial casting comprises metal and/or a fiber-reinforced plastic. Here, it is generally the case that one of the partial castings is the rim tape or part of the rim tape, and the second partial casting is the rim star or the wheel disk. The separation of the rim tape and the wheel disk or rim star has the additional disadvantage that the forces acting on the wheel have to be transmitted at the connection site, in which case a weak point can be created by the additional connection.

A further plastics wheel made of a polymer material is also disclosed in DE-U 82 05 082. The vehicle wheel disclosed therein has a rim tape and spokes, with which a nave of the wheel is connected to the rim tape. The wheel nave, the spokes and the rim tape are produced from a plastics material here and are connected integrally to one another. Here, too, it is disadvantageous that the plastic can deform and creep, particularly in the case of high forces which are transmitted to the wheel. Furthermore, the wheel does not afford sufficient protection against damage, as can arise upon contact with a curbstone in the case of careless driving.

A further disadvantage of the vehicle wheels made of a plastics material as are known from the prior art is that they generally have a wheel disk or a multiplicity of spokes so as to obtain the necessary stability, and therefore it is impossible, or possible only to a very limited extent, to realize different wheel designs.

It is therefore an object of the present invention to provide a wheel for a motor vehicle, comprising a wheel body with a rim tape for receiving a tire and a rim star or a wheel disk, which has a sufficient stability and also makes a multiplicity of different designs possible.

The object is achieved by a wheel for a motor vehicle, comprising a wheel body with a rim tape for receiving a tire and a rim star or a wheel disk, through-holes for receiving fastening means of the wheel body on a vehicle axle being formed in the rim star or in the wheel disk, and the wheel body being produced from a strong polymer material and being connected non-positively, positively or integrally to a cap, the cap covering the rim star or the wheel disk.

The non-positive, positive or integral connection between the cap and the wheel body provides additional stability of the wheel. In this case, the cap acts as additional reinforcement of the wheel. Furthermore, the separate production of the wheel body and the cap makes it possible to mass produce the wheel body, for example by an extrusion process, injection molding process or casting process, it being possible for differently designed caps to be applied to in each case identically molded wheel bodies, such that, depending on the cap used, a different design of the wheel is possible and at the same time the ribbed structure of the wheel body can be concealed behind the cap. By using the same wheel body for different caps, it is possible to simplify the production of the wheels for the motor vehicle, since different molds are not required for different wheel bodies. The design of the wheel is given exclusively by the design of the cap here.

In one embodiment, the cap is connected to the wheel body on one side. In this case, the cap is attached to the outer side of the wheel body. Alternatively, it is also possible to provide two caps, one cap being attached to the outer side of the wheel and one cap being attached to the inner side of the wheel. The use of the second cap achieves a stability of the wheel which is further improved compared to the use of only one cap.

The cap can be produced from a thermoplastic polymer material, a thermosetting polymer material or from a metal, for example. If the cap is produced from a thermoplastic polymer material, it is particularly advantageous if the cap is connected positively to the wheel body, for example by a welding process. In addition to welding the cap to the wheel body, it is alternatively also possible to connect the cap to the wheel body by an adhesive bonding process, for example.

A non-positive connection between the cap and the wheel body is also possible if the cap is produced from a thermoplastic or thermosetting polymer material. In this case, it is possible, for example, to connect the cap to the wheel body by screwing or riveting.

If the cap is produced from a metal, the cap is preferably connected non-positively to the wheel body. In this case, the connection is made in the manner described above, for example by screwing or riveting. A positive connection is also possible if the cap is produced from a metal. In this case, it is possible, for example, to encapsulate the cap by injection molding with the plastics material for the wheel body.

Furthermore, so-called organosheets, i.e. thermoplastic, flat semi-finished products reinforced by continuous fibers, or individual preimpregnated thermoplastic tapes are also suitable as the material for the cap.

A thermosetting or a thermoplastic material is used as the material for the wheel body. This material may be used in a filled or unfilled state. With preference, however, filled polymers are used.

Suitable, for example, as polymers for the wheel body and for the cap are natural and synthetic polymers or derivatives thereof, natural resins and synthetic resins and derivatives thereof, proteins, cellulose derivatives and the like. These may be—but do not have to be—chemically or physically curing, for example air-curing, radiation-curing or temperature-curing.

Apart from homopolymers, copolymers or polymer blends may also be used.

Preferred polymers are ABS (acrylonitrile-butadiene-styrene); ASA (acrylonitrile-styrene-acrylate); acrylated acrylates; alkyd resins; alkylene vinylacetates; alkylene-vinylacetate copolymers, particularly methylene vinylacetate, ethylene vinylacetate, butylene vinylacetate; alkylene-vinylchloride copolymers; amino resins; aldehyde and ketone resins; cellulose and cellulose derivatives, particularly hydroxyalkyl cellulose, cellulose esters, such as acetates, propionates, butyrates, carboxyalkyl celluloses, cellulose nitrates; epoxy acrylates; epoxy resins; modified epoxy resins, for example bifunctional or polyfunctional bisphenol-A or bisphenol-F resins, epoxy-novolak resins, bromated epoxy resins, cycloaliphatic epoxy resins; aliphatic epoxy resins, glycidyl ether, vinyl ether, ethylene-acrylic acid copolymers; hydrocarbon resins; MABS (transparent ABS comprising acrylate units); melamine resins; maleic acid-anhydride copolymers; (meth)acrylates; natural resins; colophony resins; shellac; phenolic resins; polyesters; polyester resins, such as phenylester resins; polysulfones (PSU); polyether sulfones (PESU); polyphenylene sulfone (PPSU); polyamides; polyimides; polyanilines; polypyroles; polybutylene terephthalate (PBT); polycarbonates (for example Makrolon® from Bayer AG); polyester acrylates; polyether acrylates; polyethylene; polyethylene thiophenes; polyethylene naphthalates; polyethylene terephthalates (PET); polyethylene terephthalate glycol (PETG); polypropylene; polymethyl methacrylate (PMMA); polyphenylene oxide (PPO); polyoxymethylene (POM); polystyrenes (PS); polytetrafluoroethylene (PTFE); polytetrahydrofuran; polyether (for example polyethylene glycol, polypropylene glycol); polyvinyl compounds, particularly polyvinylchloride (PVC), PVC copolymers, PVdC, polyvinylacetate and copolymers thereof, optionally partially hydrolyzed polyvinyl alcohol, polyvinyl acetals, polyvinyl acetates, polyvinyl pyrrolidone, polyvinyl ether, polyvinyl acrylates and methacrylates in solution and as a dispersion as well as copolymers thereof, polyacrylates and polystyrene copolymers; polystyrene (toughened or non-toughened); polyurethanes, uncrosslinked or crosslinked with isocyanates; polyurethane acrylates; styrene acrylonitrile (SAN); styrene-acrylic copolymers; styrene-butadiene block copolymers (for example Styroflex® or Styrolux® from BASF SE, K-Resin™ from TPC); proteins, for example casein; SIS; triazine resin, bismaleimide-triazine resin (BT), cyanate ester resin (CE) or allylated polyphenylene ether (APPE). Furthermore, blends of two or more polymers may be used.

Particularly preferred polymers are acrylates, acrylate resins, cellulose derivatives, methacrylates, methacrylate resins, melamine and amino resins, polyalkylenes, polyimides, epoxy resins, modified epoxy resins, for example bifunctional or polyfunctional bisphenol-A or bisphenol-F resins, epoxy-novolak resins, bromated epoxy resins, cycloaliphatic epoxy resins; aliphatic epoxy resins, glycidyl ether, cyanate ester, vinyl ether, phenolic resins, polyimides, melamine resins and amino resins, polyurethanes, polyesters, polyvinyl acetals, polyvinyl acetates, polystyrenes, polystyrene copolymers, polystyrene acrylates, styrene-butadiene block copolymers, styrene-acrylonitrile copolymers, acrylonitrile-butadiene-styrene, acrylonitrile-styrene acrylate, polyoxymethylene, polysulfones, polyether sulfones, polyphenylene sulfone, polybutylene terephthalate, polycarbonates, alkylene vinylacetates and vinylchloride copolymers, polyamides, cellulose derivatives as well as copolymers thereof and blends of two or more of these polymers.

Particularly preferred polymers are polyamides, for example polyamide 4, polyamide 6, polyamide 7, polyamide 8, polyamide 9, polyamide 11, polyamide 12, polyamide 46, polyamide 66, polyamide 69, polyamide 610, polyamide 612, polyamide 613, polyamide 1212, polyamide 1313, polyamide 6T, polyamide 9T, polyamide MXD6, polyamide 6I, polyamide 6-3-T, polyamide 6/6T, polyamide 6/66, polyamide 6/12, polyamide 66/6/610, polyamide 6I/6T, polyamide PACM 12, polyamide 6I/6T/PACM, polyamide 12/MACMI, polyamide 12/MACMT or polyamide PDA-T, with preference polyamide 46, polyamide 6, polyamide 11, polyamide 12, polyamide 66, polyamide 66/6, polyamide 6/10 or polyamide 6/12 as well as partially aromatic polyamide, for example 6T/6, 6T/66, 6T/6I, polypropylene, polysulfones, polyether sulfones, polyphenylene sulfones, polybutylene terephthalate as well as blends thereof.

Customary additives may be admixed with the individual polymers, for example plasticizers, crosslinking agents, impact modifiers or flame retardants.

The polymer material is preferably reinforced. In particular, the polymer material is fiber-reinforced. Any fibers that are customary for reinforcement and are known to a person skilled in the art may be used for the reinforcement. Suitable fibers are, for example, glass fibers, carbon fibers, aramid fibers, boron fibers, basalt fibers, metal fibers, mineral fibers or potassium titanate fibers. The fibers may be used in the form of short fibers, long fibers or continuous fibers. The fibers may also be oriented or randomly arranged in the polymer material. In particular when continuous fibers are used, however, an oriented arrangement is usual. The fibers may in this case be used for example in the form of individual fibers, fiber strands, mats, woven or knitted structures or rovings. If the fibers are used in the form of continuous fibers, as rovings or as fiber mats, the fibers are usually placed in a mold and then encapsulated with the polymer material. The wheel body produced in this way may be a single-layered or multi-layered construction. In the case of a multi-layered construction, the fibers of the individual layers may in each case be directed in the same direction or the fibers of the individual layers are turned at an angle of −90° to +90° in relation to one another.

Within the context of the present invention, short fibers are understood to mean fibers having a length in the granules of less than 5 mm. Long fibers are fibers in granules having a length in the range of 5 to 30 mm, preferably in the range of 7 to 20 mm. By processing the granules, the long fibers are generally shortened, and therefore in the finished component these generally have a length which can range from in the region of 0.1 mm up to the maximum dimension of the granules which are used. In the case of customarily used granule sizes, the maximum length is in the range of up to 12 mm. In the case of granules having greater dimensions, the maximum length of the fibers can also lie above this value.

Long fibers are used with preference. If long fibers are used, they are usually admixed with the polymer compound before curing. The main body of the wheel body may be produced, for example, by extrusion, injection molding or casting. With preference, the entire wheel body is produced by injection molding or casting. The long fibers are generally randomly arranged in the wheel body. If the wheel body is produced by an injection molding process, the long fibers may be oriented by the polymer compound that comprises the fibers being forced through an injection nozzle into the mold. The proportion of the fibers in the polymer compound is preferably 30 to 70% by weight, in particular 45 to 65% by weight.

In a further embodiment, the polymer material comprises a mixture of short fibers and long fibers. In this case, the proportion of long fibers in the overall fiber proportion is preferably 5 to 95% by weight, and the proportion of short fibers is accordingly 95 to 5% by weight. With particular preference, the proportion of long fibers based on the overall fiber proportion is in the range of 15 to 85% by weight, and the proportion of short fibers is accordingly 85% to 15% by weight.

In addition to the fibers, the plastics material may also comprise any other fillers that are known to a person skilled in the art and have the effect of increasing stiffness and/or strength. These also include, inter alia, any desired particles without a preferential direction. Such particles are generally spherical, plate-shaped or cylindrical. The actual form of the particles may in this case deviate from the idealized form. Thus, spherical particles in particular may in reality also be for example droplet-shaped or flattened.

Apart from fibers, reinforcing materials that are used are, for example, graphite, chalk, talc and nanoscale fillers.

Glass fibers or carbon fibers are used with particular preference for reinforcement. Glass-fiber-reinforced polyamides are particularly preferred as the material for producing the wheel body.

If polyamides are used for reinforcement, it is possible to produce the rim by a so-called polyamide RIM process. To this end, continuous fibers are placed in a mold and impregnated with a monomer solution. Then, the monomer solution is cured to form the polymer.

In a preferred embodiment, a circumferential sacrificial rib is formed on the wheel body and/or on the cap. The sacrificial rib serves as protection for the actual wheel and may be damaged, for example, upon contact with a curbstone in the case of careless driving. The sacrificial rib is preferably designed such that it can easily be replaced if it is damaged. To this end, it is particularly advantageous if the sacrificial rib is detachably connected to the cap and/or to the wheel body. In this respect, it is possible, for example, for the sacrificial rib to be screwed and/or snap-fitted to the wheel body and/or to the cap. Upon contact between the wheel and a curbstone, the sacrificial rib means that only the sacrificial rib is damaged and the wheel itself remains undamaged. This allows the wheel to be easily repaired, without having to exchange the entire wheel.

Alternatively, it is also possible to connect the sacrificial rib positively to the cap and/or the wheel body.

The sacrificial rib is preferably oriented circumferentially or radially or is implemented in an intersecting rib structure or interrupted form or in any desired form.

In a preferred embodiment, the cap has the sacrificial rib, the sacrificial rib being produced from a polymer material which is reinforced with respect to the polymer material of the cap. On account of the fact that the sacrificial rib is produced from a polymer material which is reinforced with respect to the polymer material of the cap, the sacrificial rib is more stable than the cap against external influences and is also not immediately damaged if the driver of the motor vehicle drives against a curbstone with the wheel, for example. As an alternative thereto, it is also possible to produce the sacrificial rib from an energy-absorbing material, for example a foam or an elastic material such as an elastomer, thermoplastic polyurethane (TPU) or a thermoplastic elastomer (TPE).

The wheel body is preferably produced by an injection molding process or a casting process. In order to make it possible to produce the wheel body in one part, it is preferred for the rim star or the wheel disk to have no undercuts. Since undercuts are avoided on the rim star or the wheel disk, it is possible to use a simply constructed mold for producing the wheel body.

For additional reinforcement, it is possible, however, for the rim star or the wheel disk or else the rim tape to have ribs. If ribs are provided on the wheel disk, these preferably extend in the radial direction. Ribs on the rim tape can be in the form of an intersecting rib structure. In this case, it is particularly preferred for the ribs to be turned with respect to the circumferential direction. With preference, the ribs here are turned by 30° to 60° with respect to the circumferential direction, for example by 45°.

To fasten the wheel on an axle of the motor vehicle, provision is made of through-holes. On account of the high forces which act on the wheel body and the through-holes, there is the risk that the wheel body will begin to creep in the region of the through-holes and as a result will be deformed. In order to avoid this, a preferred embodiment provides for the through-holes for receiving fastening means to each receive a sleeve which is made of a metal or a ceramic and is connected positively to the polymer material of the wheel body. The positive connection of the sleeve made of the metal or the ceramic is achieved in that, during the production of the wheel body, firstly the sleeves are placed in the mold and then the sleeves are encapsulated by injection molding with the polymer material for the wheel body.

Aluminum, iron, titanium or magnesium are suitable, for example, as the metal for the sleeves, it also being possible for the metals to be present as mixtures or in the form of alloys. If iron is used, it is preferably in the form of steel. Alternatively, the sleeves may also be produced as cast-iron parts, in which case the iron may be used both in the form of cast steel and gray cast iron.

Suitable ceramics from which the sleeves can be produced are, for example, ceramics based on aluminum oxide or silicon oxide.

As an alternative to the use of sleeves which are received in the through-holes for receiving fastening means, it is also possible to provide an adapter, which is connected to the rim star or the wheel disk in the region of the nave, the adapter having protuberances which engage in depressions in the region of the rim star or the wheel disk. The wheel is then fastened to an axle of the motor vehicle with the adapter. The adapter can be formed in one part with the wheel mounting on the vehicle axle or can be a separate part, in which case the adapter can be formed in one part with the wheel and has at least one area which is in contact with the wheel mounting on the vehicle axle. The adapter can be produced from the same metals as described above for the sleeves. Alternatively, it is also possible to produce the adapter from a ceramic.

For force transmission, the adapter has protuberances which engage in depressions in the rim star or in the wheel disk. As a result of the protuberances, which engage in depressions on the wheel, no force is transmitted directly to the wheel by friction and the deformation of the wheel caused by creep in the region of the fastening means is reduced to the extent that it is no longer harmful to the functioning of the wheel.

The configuration according to the invention of the wheel with a wheel body and a separate cap makes it possible for the cap to have recesses, these being arranged at positions at which recesses are also located on the rim star of the wheel body. This results in optical unity between the rim star of the wheel body and the cap, where any desired designs of the cap are possible without parts of the wheel body being visible in the region of the recesses of the cap. This permits optical unity of the wheel body and the cap.

A process for producing the wheel comprises the following steps:
(a) the wheel body is molded,
(b) the cap is molded,
(c) the wheel body and the cap are connected.

The wheel body and the cap can be molded here by any desired injection molding or injection-compression molding process known to a person skilled in the art. As an alternative to injection molding or injection-compression molding, it is also possible to produce the wheel body and/or the cap by any other casting process. Thus, for example, fiber composites can be encapsulated with a monomer solution and then cured. Furthermore, it is also possible to mold and to cure a fiber composite impregnated with monomer solution, this molding process being suitable in particular for producing the cap. However, it is particularly preferable to mold the cap and the wheel body in an injection molding process.

On the one hand, the wheel body and the cap can be connected after the wheel body and the cap have been produced, for example by welding, adhesive bonding, riveting, screwing or snap-fitting. Alternatively, it is also possible to firstly produce the cap, to place the latter in a mold for producing the wheel body and then to encapsulate the cap or to encapsulate it by injection molding with the polymer material for the wheel body, as a result of which the wheel body and the cap are connected to form an integral component.

In addition to the adhesive bonding, welding, riveting, snap-fitting or screwing or the encapsulation of the cap by injection molding in order to connect the cap to the wheel body, it is also possible to connect the cap to the wheel body by way of a loop connection or a bolt connection, for example. In the case of a loop connection, the force is transmitted, for example, by loop-like partial or complete looping of a bolt or a flange by a strand or a cord.

To connect the wheel body and the cap, it is particularly preferable if at least one first mold part which holds and partially receives the wheel body and at least one second mold part which holds and partially receives the cap are provided at respective connection regions, wherein the at least one first mold part does not overlap the connection regions of the wheel body and the at least one second mold part does not overlap the connection regions of the cap, and wherein the at least one first mold part and the at least one second mold part are drawn closer to one another, with the mutually facing connection regions of the wheel body and of the cap, in such a way that the connection regions of the wheel body and of the cap are placed against one another and in the process are integrally connected, and during the connection the wheel body is held in the at least one first mold part and the cap is held in the at least one second mold part.

The integral connection by way of which the wheel body and the cap are connected to one another is preferably an adhesive bond or welded connection.

In the case of an adhesive bond, an adhesive is applied to the connection region of the wheel body and/or to the connection region of the cap before the connection regions of the wheel body and of the cap are placed against one another. The cap and the wheel body are held in this case until the adhesive has cured to such an extent that the wheel body and the cap can no longer be displaced with respect to one another.

It is preferable, however, to weld the cap and the wheel body to one another. In this case, it is possible, for example, before the connection regions of the wheel body and of the cap are placed against one another, to introduce a heating apparatus into a space between the connection regions of the wheel body and of the cap, and to incipiently melt the connection regions of the wheel body and of the cap, to remove the heating apparatus again after the connection regions have been incipiently melted and then to place the incipiently melted connection regions against one another, such that the connection regions of the wheel body are welded to the connection regions of the cap.

In one embodiment, a movable carrier is provided for at least one of the first and second mold parts and, after the wheel body and the cap have been molded, is moved in such a way that the connection regions of the wheel body and of the cap face one another. This makes it possible to mold the wheel body and the cap and to connect them to one another without at least one of these parts having to be removed from the molding tool and/or without the molding tool with the part molded therein having to be positioned in another machine. In this case, the first and second mold parts, in which the wheel body and the cap are received, are each mold parts of the molding tool in which the wheel body or the cap have been molded. It is very particularly preferable for the molding tools for the wheel body and for the cap to be injection molding tools, in the case of which the first mold part for the wheel body or the second mold part for the cap are each closed with further mold parts, such that the shape for the wheel body or for the cap is formed on the inside.

Exemplary embodiments of the invention are illustrated in the figures and are explained in more detail in the description which follows.

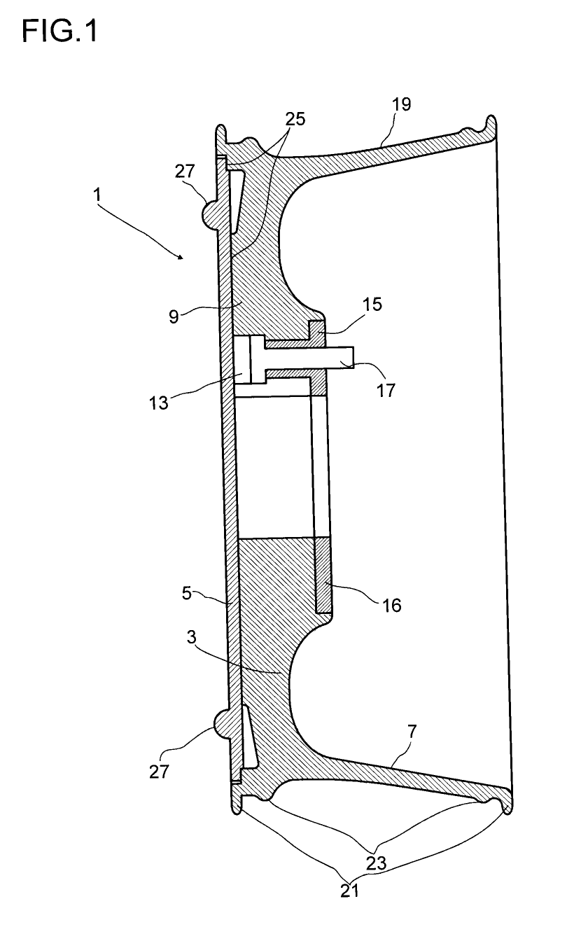

FIG. 1 shows a section through a wheel designed according to the invention,

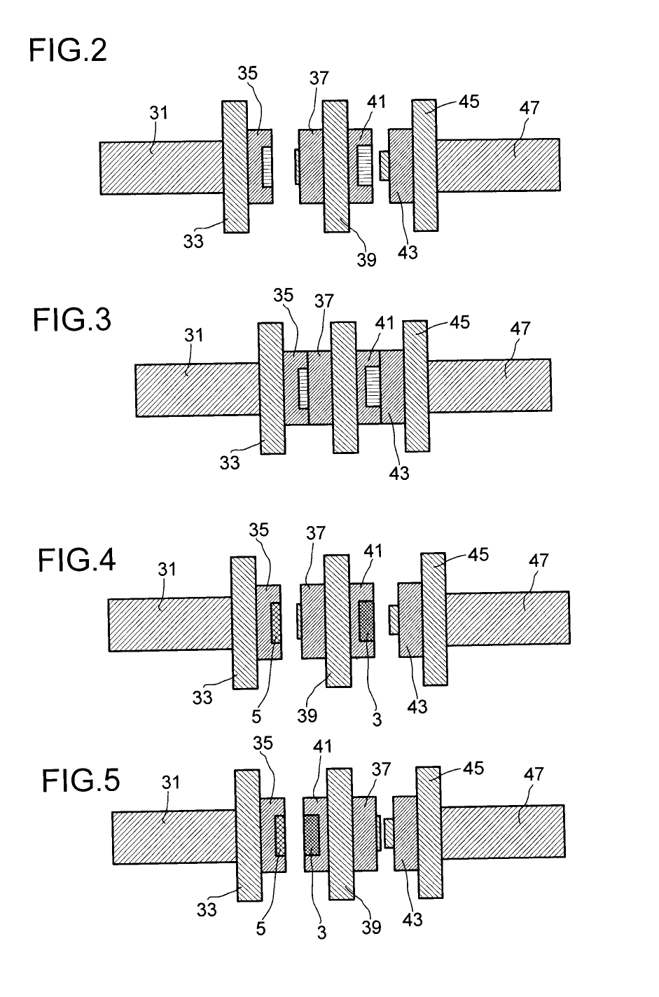

FIGS. 2 to 8 show steps for a process for producing the wheel.

FIG. 1 shows a section through a wheel designed according to the invention for a motor vehicle.

A wheel 1 for a motor vehicle comprises a wheel body 3 and a cap 5.

According to the invention, the wheel body 3 is produced from a polymer material. In order to obtain a sufficiently great stability of the wheel body 3, the polymer material is preferably reinforced. Fibers in the form of short fibers, long fibers or continuous fibers can be used for reinforcement. The use of long fibers is preferred. Thermoplastic or thermosetting polymers as described above are suitable as the polymer material for the wheel body 3.

The wheel body 3 comprises a rim tape 7 for receiving a tire and a rim star 9. Through-holes 13 are made in the rim star 9, through which through-holes it is possible to guide fastening means for fastening the wheel body 3 on a vehicle axle, usually on a brake drum or brake disk.

With preference, the through-holes 13 each receive a sleeve 15. The sleeve 15 serves for additional stabilization in the region of the respective through-hole 13, in order to avoid damage to the wheel body 3 as a result of the inserted fastening means. The sleeve is usually produced from a metal or a ceramic and is preferably molded during the production of the wheel body 3, such that the sleeve 15 is connected positively to the wheel body 3. In addition to the sleeve 15, it is also possible to provide an insert 16, which forms a contact surface for the assembly of the wheel 1. In this case, it is possible to provide the insert 16 and the sleeves 15 as separate components or to form the sleeves 15 in one piece with the insert 16.

In order to fasten the wheel body 3 to the vehicle axle, wheel bolts 17 are used as suitable fastening means, for example. The wheel bolts 17 allow the wheel body 3 to be detachably connected to the vehicle axle, such that the wheel can easily be disassembled, for example if the wheel is damaged or if it is necessary to change the tire.

The rim tape 7 usually comprises an outer rim well 19. At its outer edges, the outer rim well 19 is terminated by a rim flange 21. The rim flange 21 serves for the mounting of a tire which has been pulled onto the wheel 1. In this respect, the tire is pressed against the rim flange 21 with its outer side.

If a tubeless tire is used, it is furthermore necessary to avoid inward displacement of the tire as a result of the pressure exerted during driving. To this end, the outer rim well 19 has so-called humps 23. The side wall of the pulled-on tire is thus held between the rim flange 21 and the hump 23, the hump 23 bearing against the inner side of the tire wall.

The cap 5 serves both for additionally stabilizing the wheel 1 and also as a design element. To this end, the cap 5 can be formed in any desired shape. If the cap 5 is designed appropriately, it can also be used for improving the aerodynamics of the motor vehicle.

The cap 5 is connected non-positively, positively or integrally to the wheel body 3. In the embodiment shown in FIG. 1, the cap 5 is connected positively to the wheel body 3.

If the cap 5 is connected non-positively to the wheel body 3, a screw connection, a groove connection or a connection by clips are suitable, for example. A positive connection, as is shown in FIG. 1, can be effected by welding or adhesive bonding, for example. To this end, the cap 5 is connected to the wheel body 3 at connection points 25. In order to obtain a stable connection, it is preferable here that the connection points 25 extend annularly over the wheel body 3. In order to achieve a welded connection, it is possible, for example, to locally heat and incipiently melt both the wheel body in the region of the connection points 25 and also the cap 5 in the region of the connection points 25, and then to press the cap 5 onto the wheel body 3. Here, the heating can be effected, for example, by friction or by the application of local heat.

If the cap 5 is produced from a material which is not thermoplastic, for example from a thermosetting material or from a metal, and therefore a connection cannot be made by welding, it is also possible to achieve a positive connection by encapsulating the cap 5 by injection molding with the polymer material of the wheel body 3, for example.

To protect the wheel against damage, for example caused by the wheel making contact with a curbstone, it is advantageous for a sacrificial rib 27 to be formed on the wheel 1. With preference, the sacrificial rib 27 is arranged annularly around the axis of the wheel 1 and, as shown here, may be formed on the cap 5. Alternatively, it is also possible to form the sacrificial rib 27 on the wheel body 3, for example in the region of the rim tape 7.

One possible process for producing the wheel 1 is shown diagrammatically in FIGS. 2 to 8.

An apparatus for producing the wheel 1 comprises a first injection molding unit 31 with a first clamp 33, which is connected to a first mold half 35 for producing the cap 5. A second mold half 37, with which the first mold half 35 is closed, is connected to a turning plate 39. A second mold half 41 for producing the wheel body 3 is attached to that side of the turning plate 39 which lies opposite the second mold half 37. A first mold half 43 for producing the wheel body can be closed by the second mold half 41. The first mold half 43 for producing the wheel body 3 is connected to a second clamp 45, which is part of a second injection molding unit 47.

In a first step, the first mold half 35 and the second mold half 37 for the cap and the first mold half 43 and the second mold half 41 for the wheel body are closed. This is shown in FIG. 3. After the first mold half 35 and the second mold half 37 for the cap 5 and the first mold half 43 and the second mold half 41 for the wheel body 3 have been closed, the polymer material for producing the cap 5 and the wheel body 3, respectively, is injected. After the plastics compounds have been cooled and solidified in the respective molds, which are formed by the mold halves 35, 37; 41, 43, the mold is opened again. This is shown in FIG. 4. In this case, the cap 5 is located in a recess in the first mold, here in the first mold half 35, and the wheel body 3 is located in a second recess, here in the second mold half 41. This is shown diagrammatically in each case by a rectangle.

In a next step, the turning plate 39 is turned, such that the cap 5 and the wheel body 3 lie opposite one another. This is shown in FIG. 5.

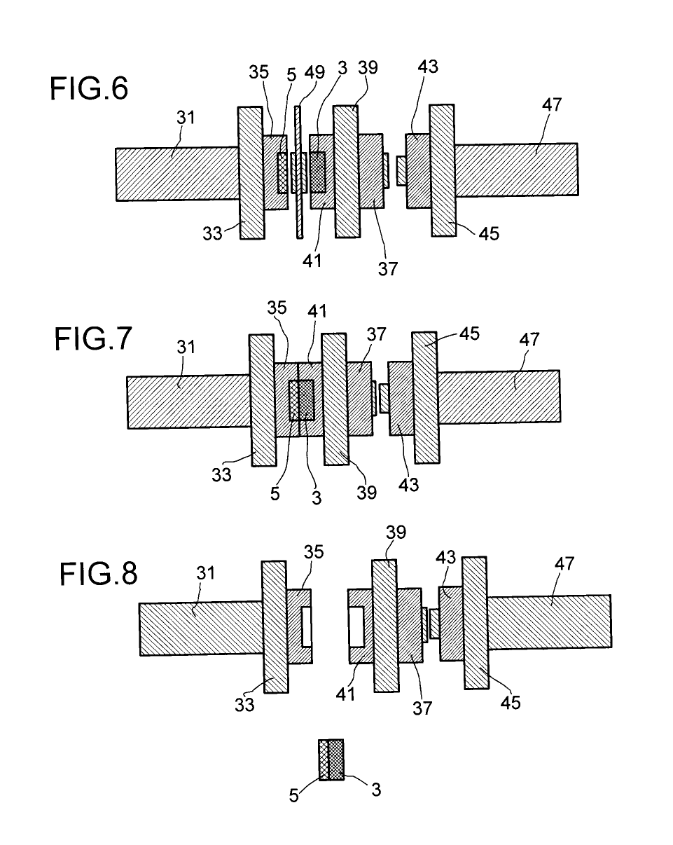

In a next step, which is shown in FIG. 6, a heating element is introduced between the cap 5 and the wheel body 3. By way of example, the heating element can be a hot-tool joint-melt welding apparatus 49. The cap 5 and the wheel body 3 are incipiently melted in the region of the connection points 25 using the welding apparatus 49. This can either be effected by contact and friction, by the welding apparatus 49 being turned about the central axis, for example, or heating is effected by radiant heating, by blowing on a hot gas or by contact with a heated part.

After the connection points 25 have been incipiently melted, in a next step the wheel body 3 and the cap 5 are connected to one another. This is shown diagrammatically in FIG. 7. As soon as the cap 5 adheres to the wheel body 3, the mold is opened again, as shown in FIG. 8, and the wheel, comprising the wheel body 3 with the cap 5 attached thereto, is removed.

Finally, the turning plate 39 is turned again, such that the first mold half 35 and the second mold half 37 for producing the cap 5 and the first mold half 43 and the second mold half 41 for producing the wheel body lie opposite one another, as shown in FIG. 2, and the injection molding process can be repeated for the next wheel.

### LIST OF REFERENCE SIGNS

1 Wheel
3 Wheel body
5 Cap
7 Rim tape
9 Rim star
13 Through-hole
15 Sleeve
16 Insert
17 Wheel bolt
19 Outer rim well
21 Rim flange
23 Hump
25 Connection point
27 Sacrificial rib
31 First injection molding unit
33 First clamp
35 First mold half
37 Second mold half
39 Turning plate
41 Second mold half
43 First mold half
45 Second clamp
47 Second injection molding unit
49 Hot-tool joint-melt welding apparatus

1. A wheel for a motor vehicle, comprising a wheel body (3) with a rim tape (7) for receiving a tire and a rim star (9) or a wheel disk, through-holes (13) for receiving fastening means (17) of the wheel body (3) on a vehicle axle being formed in the rim star (9) or the wheel disk, wherein the wheel body (3) is produced from a reinforced polymer material and is connected non-positively or positively or integrally to a cap (5), the cap (5) covering the rim star (9) or the wheel disk.

2. The wheel according to claim 1, wherein the cap (5) is produced from a thermoplastic polymer material, a thermosetting material or a metal.

3. The wheel according to claim 1, wherein the polymer material for the wheel body (3) and/or for the cap (5) is selected from polybutylene terephthalate, polyethylene sulfone, polysulfone, polypropylene or polyamide.

4. The wheel according to claim 1, wherein short fibers, long fibers or continuous fibers are used for reinforcing the polymer material.

5. The wheel according to claim 4, wherein the fibers for reinforcing the polymer material are glass fibers, carbon fibers, aramid fibers, potassium titanate fibers, boron fibers, basalt fibers, mineral fibers or metal fibers.

6. The wheel according to claim 1, wherein the wheel body (3) and/or the cap (5) has a sacrificial rib.

7. The wheel according to claim 6, wherein the cap (5) has the sacrificial rib, the sacrificial rib being produced from a polymer material which is reinforced with respect to the polymer material of the cap (5) or an elastic or an energy-absorbing polymer material.

8. The wheel according to claim 1, wherein the rim star (9) or the wheel disk have no undercuts.

9. The wheel according to claim 1, wherein the through-holes (13) for receiving fastening means (17) each receive a sleeve (15) which is made of a metal or a ceramic and is connected positively to the polymer material of the wheel body (3).

10. The wheel according to claim 1, wherein the cap (5) has recesses, which are arranged at positions at which recesses are also located on the rim ring (9) of the wheel body (3).

11. A process for producing the wheel according to claim 1, comprising the following steps:
(a) the wheel body (3) is molded,
(b) the cap (5) is molded,
(c) the wheel body (3) and the cap (5) are connected.

12. The process according to claim 11, wherein the cap (5) is adhesively bonded, welded, riveted, snap-fitted or screwed to the wheel body (3) or is connected by way of a loop connection or bolt connection.

13. The process according to claim 11, wherein, to connect the wheel body (3) and the cap (5), at least one first mold part which holds and partially receives the wheel body (3) and at least one second mold part which holds and partially receives the cap (5) are provided at respective connection regions, wherein the at least one first mold part does not overlap the connection regions of the wheel body (3) and the at least one second mold part does not overlap the connection regions of the cap (5), and wherein the at least one first mold part and the at least one second mold part are drawn closer to one another, with the mutually facing connection regions of the wheel body (3) and of the cap (5), in such a way that the connection regions of the wheel body (3) and of the cap (5) are placed against one another and in the process are integrally connected, and during the connection the wheel body (3) is held in the at least one first mold part and the cap (5) is held in the at least one second mold part.

14. The process according to claim 13, wherein the integral connection is an adhesive bond or welded connection.

15. The process according to claim 13, wherein, before the connection regions of the wheel body (3) and of the cap (5) are placed against one another, a heating apparatus is introduced into a space between the connection regions of the wheel body (3) and of the cap (5), and the connection regions of the wheel body (3) and of the cap (5) are incipiently melted, the heating apparatus is removed again after the connection regions have been incipiently melted and then the incipiently melted connection regions are placed against one another, such that the connection regions of the wheel body (3) are welded to the connection regions of the cap (5).

16. The process according to claim 13, wherein a movable carrier is provided for at least one of the first and second molding tool parts and, after the wheel body (3) and the cap (5) have been molded, is moved in such a way that the connection regions of the wheel body (3) and of the cap (5) face one another.

17. The process according to claim 11, wherein the cap (5) and the wheel body (3) are each molded by an injection molding process.
